(19) United States
(12) Patent Application Publication
(10) Pub. No.: US 2018/0161807 A1
(43) Pub. Date: Jun. 14, 2018

(54) MANUFACTURING METHOD OF POROUS THERMAL INSULATION COATING LAYER

(71) Applicant: Hyundai Motor Company, Seoul (KR)

(72) Inventors: Bokyung KIM, Yongin-si (KR); In Woong LYO, Suwon-si (KR); Woong Pyo HONG, Yongin-si (KR); Hong Kil BAEK, Seoul (KR); Su Jung NOH, Seoul (KR); Seung Jeong OH, Suwon-si (KR); Seungkoo LEE, Yongin-si (KR); Seung Woo LEE, Seoul (KR)

(73) Assignee: Hyundai Motor Company, Seoul (KR)

(21) Appl. No.: 15/587,186

(22) Filed: May 4, 2017

(30) Foreign Application Priority Data
Dec. 13, 2016 (KR) 10-2016-0169391

(51) Int. Cl. B05D 3/02; B05D 1/12

(52) U.S. Cl. CPC B05D 3/0254; B05D 1/12

(57) ABSTRACT

Disclosed herein is a manufacturing method of a porous thermal insulation coating layer. In the manufacturing method, a porous thermal insulation coating layer having excellent close adhesion may be uniformly formed within a shorter time and the porous thermal insulation coating layer may be applied to an internal combustion engine, thereby making it possible to secure low thermal conductivity and low volume thermal capacity.

### CROSS-REFERENCE TO RELATED APPLICATION

The present application claims under 35 U.S.C. § 119(a) the benefit of Korean Patent Application No. 10-2016-0169391, filed on Dec. 13, 2016, the entire contents of which are incorporated herein by reference.

### BACKGROUND OF THE INVENTION

### Field of the Invention

The present invention relates to a manufacturing method of a porous thermal insulation coating layer. More particularly, the present invention relates to a manufacturing method of a porous thermal insulation coating layer capable of securing low thermal conductivity and low volume thermal capacity. The porous thermal insulation coating layer can be applied to an internal combustion engine to provide excellent durability.

### Description of Related Art

An internal combustion engine is an engine allowing combustion gas itself generated by combustion of fuel to directly act a piston, a turbine blade, or the like, to convert thermal energy of fuel into mechanical work. The internal combustion engine mainly indicates a reciprocating engine moving a piston in a cylinder by igniting and exploding mixed gas of fuel and air, but a gas turbine, a jet engine, a rocket, and the like, are also included in the internal combustion engine.

The internal combustion engine is classified into a gas engine, a gasoline engine, a kerosene engine, a diesel engine, and the like, depending on fuel used in the internal combustion engine. In the kerosene·gas·gasoline engine, an electric spark is ignited by a spark plug, and in the diesel engine, fuel is injected into high-temperature and high-pressure air to thereby spontaneously combust. There are a 4-stroke cycle type engine and a 2-stroke cycle type engine depending on a stroke operation of the piston.

Generally, it is known that an internal combustion engine of a vehicle has thermal efficiency of 15% to 35%, and at the maximum efficiency of the internal combustion engine as described above, about 60% or more of total energy is consumed due to thermal energy released to the outside through a wall of the internal combustion engine, exhaust gas, and the like.

By decreasing the amount of thermal energy released to the outside through the wall of the internal combustion engine, as described above, it is possible to increase efficiency of the internal combustion engine. Methods of installing a thermal insulation material on the outside of the internal combustion engine, methods of partially changing materials or structure of the internal combustion engine, and/or methods of developing a cooling system of the internal combustion engine have been used.

Particularly, in the case in which release of heat generated in the internal combustion engine to the outside through the wall of the internal combustion engine is minimized, efficiency of the internal combustion engine and fuel efficiency of a vehicle may be improved. However, research into the thermal insulation material or thermal insulation structure capable of being maintained for a long period of time in the internal combustion engine to which high-temperature and high-pressure conditions are repeatedly applied has not been sufficiently conducted.

Therefore, there is a need to develop a novel thermal insulation material capable of having low thermal conductivity and excellent thermal resistance and being applied to the internal combustion engine to thereby be maintained for a long period of time.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a manufacturing method of a porous thermal insulation coating layer having advantages of securing low thermal conductivity and low volume thermal capacity and being applied to an internal combustion engine to have excellent durability.

An exemplary embodiment of the present invention are directed to providing a manufacturing method of a porous thermal insulation coating layer including:

forming a granule including a ceramic compound and a polymer compound;

spraying the granule on a substrate at a rate of 1 μm/min to 100 μm/min to form a granule coating layer; and

forming pores by thermally treating the substrate on which the granule coating layer is formed at a temperature of 300° C. to 500° C. to remove the polymer compound.

Hereinafter, the manufacturing method of a porous thermal insulation coating layer according to the exemplary embodiment of the present invention will be described in more detail.

Technical terms used in the present specification are only to describe a specific embodiment, and do not limit the present invention.

Singular forms used in the present specification include plural forms as long as they do not have clearly different meanings. Further, the term ‘include’ used in the present specification is to specify a specific property, region, integer, step, operation, factor, or component, but does not exclude presence or addition of another specific property, region, integer, step, operation, factor, or component.

According to the study of the present inventors, it was confirmed that a porous thermal insulation coating layer having excellent close adhesion may be uniformly formed within a shorter time by a method of spraying a granule including a ceramic compound and a polymer compound on a substrate at a predetermined rate to form a coating layer and forming pores by thermally treating the coating layer to remove the polymer compound. In addition, the porous thermal insulation coating layer formed by the above-mentioned method may secure low thermal conductivity and low volume thermal capacity, and have excellent durability even under harsh conditions of high temperature and high pressure, thereby making it possible to secure further improved long-term reliability.

In relation to this, in the case of composite coating using porous aerogel and an organic binder according to the related art, fine cracks may be formed in a coating layer by thermal decomposition of the organic binder under an operation environment of an internal combustion engine, and the coating layer may be delaminated, etc., such that it is difficult to secure long-term reliability. Further, in the case of thermal spray coating using plasma, a coating material may be exposed to a high temperature, such that an internal pore structure, for example, aerogel, or the like, is highly likely to be deformed, and it is difficult to obtain a coating layer having a high porosity. Further, in the case of coating using an aerosol deposition method, uniformity of a coating layer may be deteriorated due to aggregation of powders, or the like, and it is difficult to secure stability of a continuous process.

As compared to the methods according to the related art described above, in the manufacturing method of a porous thermal insulation coating layer according to an exemplary embodiment of the present invention, referring to FIG. 1, a porous thermal insulation coating layer having excellent close adhesion may be formed within a shorter time by mixing a ceramic compound and a polymer compound to prepare a granule, spraying the granule on a substrate at a predetermined rate to form a granule coating layer, and thermally treating the granule coating layer. Particularly, in the case of spraying the granule under vacuum, it is possible to obtain an improved effect. A large area of 1000 cm² or more may be uniformly coated by spraying the granule at the predetermined rate as described above, thereby making it possible to secure high coating reliability and improve entire process efficiency. Further, since the above-mentioned processes are performed under an entirely mild condition, and the pores are formed by thermal treatment after forming the granule coating layer, a risk of deformation of the pore structure may be decreased, and a porous thermal insulation coating layer having a high porosity may be provided.

According to an exemplary embodiment of the present invention as described above, the manufacturing method of a porous thermal insulation coating layer may include forming a granule including a ceramic compound and a polymer compound; spraying the granule on a substrate at a rate of 1 μm/min to 100 μm/min to form a granule coating layer; and forming pores by thermally treating the substrate on which the granule coating layer is formed at a temperature of 300° C. to 500° C. to remove the polymer compound.

Forming of Granule

According to the exemplary embodiment of the present invention, the granule includes the ceramic compound and the polymer compound, and may be prepared by granulating a mixture of these compounds.

The ceramic compound, which is an ingredient for imparting a thermal insulation effect to an arbitrary substrate, may include at least one or two or more (e.g., at least 1, 2, 3, 4, 5, 6 or more) metal oxides.

More specifically, the ceramic compound may include oxides in which one or two or more metal elements selected from the group consisting of silicon (Si), aluminum (Al), titanium (Ti), zirconium (Zr), calcium (Ca), magnesium (Mg), yttrium (Y), and cerium (Ce) are each bonded to oxygen. In more detail, the ceramic compound may be yttria-stabilized zirconia (YSZ) including zirconium oxide and yttrium oxide.

As the ceramic compound, a ceramic powder having an average diameter of 1 μm to 50 μm (e.g., about 1 μm, 5, 10, 15, 20, 25, 30, 35, 40, 45 or 50 μm) may be used. A method of obtaining the ceramic powder is not particularly limited, but a grinding method known in the art, for example, a ball mill method, or the like, may be used.

The polymer compound is an ingredient for providing pores in empty places by being finally removed from the granule coating layer by thermal treatment after being mixed with the ceramic compound to form the granule and be coated on the substrate.

The polymer compound may include one or more compounds selected from the group consisting of polytetrafluoroethylene (PTFE), a tetrafluoroethylene-perfluoroalkylvinylether copolymer (PFA), a tetrafluoroethylene-hexafluoropropylene copolymer (FEP), an ethylene-tetrafluoroethylene copolymer (ETFE), a tetrafluoroethylene-chlorotrifluoroethylene copolymer (TFE/CTFE), ethylene-chlorotrifluoroethylene (ECTFE), polyethylene, polystyrene, poly(methyl methacrylate), poly(ethylene oxide), poly(vinyl alcohol), and polyamide.

Particularly, it is preferable that the polymer compound, which is the ingredient removed by thermal treatment after the granule coating layer is formed, is polytetrafluoroethylene in order to increase efficiency of a thermal treatment process and prevent deformation of the pores during the thermal treatment process.

Meanwhile, a method of forming the granule including the ceramic compound and the polymer compound is not particularly limited, and a granulation method known in the art, for example, a fluidized bed granulation method, a dry granulation method, or the like, may be used. At the time of forming the granule, if necessary, a suitable solvent may be used, and drying of the formed granule may be additionally performed.

Here, contents of the ceramic compound and the polymer compound forming the granule may be determined in consideration of ingredients of each of the compounds and characteristics such as the porosity, and the like, to be imparted to the porous thermal insulation coating layer. However, in the case in which the content of the polymer compound is excessively low, it may be difficult to secure a sufficient porosity. On the contrary, in the case in which the content of the polymer compound is excessively high, it may be difficult to secure a sufficient thermal insulation property, and the coating layer may be easily delaminated.

Therefore, it is preferable that the granule includes about 80 to 99.9 wt % (e.g., about 80 wt %, 81, 82, 83, 84, 85, 86, 87, 88, 89, 90, 91, 92, 93, 94, 95, 96, 97, 98, 99, 99.1, 99.2, 99.3, 99.4, 99.5, 99.6, 99.7, 99.8, or about 99.9 wt %) of the ceramic compound and 0.1 to 20 wt % (e.g., about 0.1, 0.5, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 wt %) of the polymer compound. More preferably, the granule may include about 85 to 99.9 wt % (e.g., about 85 wt %, 86, 87, 88, 89, 90, 91, 92, 93, 94, 95, 96, 97, 98, 99, 99.1, 99.2, 99.3, 99.4, 99.5, 99.6, 99.7, 99.8, or about 99.9 wt %) of the ceramic compound and 0.1 to 15 wt % of the polymer compound.

In addition, a size of the granule may be determined in consideration of efficiency of a process of spraying the granule by a GSV (granule spray in vacuum) process, uniformity of the coating layer, and the like. However, when the size of the granule is excessively small, it may be difficult to secure a sufficient porosity. On the contrary, when the size of the granule is excessively large, it may be difficult to implement sufficient close adhesion with the substrate and uniformly form the coating layer. Therefore, it is preferable that the granule has an average diameter of about 50 μm to about 500 μm (e.g., about 50 μm, 60, 70, 80, 90, 100, 110, 120, 130, 140, 150, 160,170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or about 500 μm) or 50 μm to 200 μm (e.g., about 50 μm, 60, 70, 80, 90, 100, 110, 120, 130, 140, 150, 160,170, 180, 190, or 200 μm). Here, the average diameter of the granule means a number average diameter based on a longest diameter of the granule.

Forming of Granule Coating Layer

According to the exemplary embodiment of the present invention, the forming of the granule coating layer may be performed by spraying the granule on the substrate at a rate of about 1 μm/min to about 100 μm/min, (e.g., about 1 μm/min, 5, 10, 15, 20, 25, 30, 35, 40, 45, 50, 55, 60, 65, 70, 75, 80 85, 90. 95, or about 100 μm/min).

That is, the porous thermal insulation coating layer having excellent close adhesion may be formed within a shorter time by spraying the granule on the substrate at the above-mentioned rate to form the granule coating layer and then thermally treating the granule coating layer. Particularly, a large area of 1000 cm² or more may be uniformly coated by the method as described above, thereby making it possible to secure high coating reliability and improve entire process efficiency.

According to the exemplary embodiment of the present invention, when a spraying rate of the granule is excessively low, uniformity of the granule coating layer and efficiency or large-area coating may be deteriorated. Therefore, it is preferable that the spraying rate of the granule is 1 μm/min or more. On the contrary, when the spraying rate of the granule is excessively high, uniformity and close adhesion of the granule coating layer may be deteriorated. Therefore, it is preferable that the spraying rate of the granule is 100 μm/min or less.

More preferably, the forming of the granule coating layer may be performed by spraying the granule on the substrate at a rate of 1 μm/min or more, 5 μm/min or more, or 10 μm/min or more. In addition, the forming of the granule coating layer may be performed by spraying the granule on the substrate at a rate of 100 μm/min or less, 90 μm/min or less, 80 μm/min or less, or 70 μm/min or less.

Meanwhile, according to the exemplary embodiment of the present invention, the forming of the granule coating layer may be performed by a method of spraying the granule on the substrate under vacuum, for example, the granule spray in vacuum (GSV) process.

The GSV process is a process of forming a dense granule coating layer by collision of the granule on the substrate using a pressure difference. The GSV process as described above may enable formation of a coating layer having uniform characteristics while enabling stable process operation under mild conditions as compared to a thermal spray coating method or aerosol deposition method.

In detail, the forming of the granule coating layer using the GSV process may include supplying the granule to a spray nozzle using compressed air; and spraying the supplied granule to the substrate provided in a vacuum chamber through the spray nozzle. To this end, in the forming of the granule coating layer, a device including the vacuum chamber provided with a substrate mounting means, a vacuum pump for maintaining a vacuum atmosphere in the vacuum chamber, the spray nozzle spraying the prepared granule in the vacuum chamber together with the compressed air, and a granule supplier transferring the prepared granule to the spray nozzle may be used.

The substrate is an arbitrary material to be coated with the porous thermal insulation coating layer. According to the exemplary embodiment of the present invention, the substrate may be, for example, an inner surface of an internal combustion engine, a component of the internal combustion engine, or the like.

The spraying may be performed at a distance at which the spray nozzle is spaced apart from the substrate by 5 mm to 200 mm, 10 mm to 200 mm, or 10 mm to 150 mm. When a spraying distance is excessively short, a coating area may be narrow, such that process efficiency may be deteriorated. On the contrary, when the spraying distance is excessively long, collision energy of the granule with the substrate is not sufficient, such that close adhesion of the coating layer may be deteriorated.

In addition, a flow rate of the compressed air and an internal pressure of the vacuum chamber may be determined in consideration of the pressure difference so that the collision energy of the granule may be sufficiently secured. In detail, the compressed air may be supplied into the vacuum chamber through the spray nozzle at a flow rate of 20 to 50 L/min, 25 to 40 L/min, or 30 to 35 L/min, together with the granule. In addition, vacuum atmosphere of 1 to 50 torr, 1 to 25 torr, or 5 to 15 torr may be maintained in the vacuum chamber.

Meanwhile, the granule coating layer may be formed at a thickness of 10 μm to 2000 μm, 20 μm to 1000 μm, 20 μm to 500 μm, or 30 μm to 300 μm. In the case in which the thickness of the granule coating layer is less than 10 μm, it is impossible to sufficiently decrease a density of a final porous thermal insulation coating layer, such that it may be difficult to decrease thermal conductivity at a suitable level or less, and a function of protecting a surface of the substrate may be deteriorated. On the contrary, in the case in which the thickness of the granule coating layer is more than 2000 μm, cracks may occur in the final porous thermal insulation coating layer, which is not preferable.

Forming of Pores

According to the exemplary embodiment of the present invention, the forming of the pores may be performed by a method of thermally treating the substrate on which the granule coating layer is formed to remove the polymer compound from the granule coating layer.

That is, the polymer compound is removed from the granule coating layer by thermal treatment, and thus the pores are formed in the empty places, thereby making it possible to provide the porous thermal insulation coating layer according to the exemplary embodiment of the present invention.

Thermal treatment may be performed at a temperature at which the polymer compound may be carbonized or pyrolyzed in the substrate on which the granule coating layer is formed. In detail, thermal treatment may be performed by heating the substrate on which the granule coating layer is formed at a temperature of about 300° C. to about 500° C. (e.g., about 300° C., 350° C., 400° C., 450° C., or about 500° C.).

A thermal treatment temperature may be changed depending on the kind of polymer compound included in the granule, but it is preferable that the thermal treatment temperature is 300° C. or more in consideration of process efficiency. However, since the thermal treatment temperature is excessively high, which may have a negative influence on close adhesion of the granule coating layer and durability of the pores, it is preferable that the thermal treatment temperature is 500° C. or less.

More preferably, thermal treatment may be performed at a temperature of 300° C. or more, 350° C. or more, or 400° C. or more. In addition, thermal treatment may be performed at a temperature of 500° C. or less, or 450° C. or less.

A thermal treatment time may be adjusted in consideration of a shape of the substrate, the kind of polymer compound included in the granule, the thickness of the granule coating layer, the thermal treatment temperature, a desired porosity to be imparted to the final porous thermal insulation coating layer, and the like.

In addition, thermal treatment may be performed so that the porous thermal insulation coating layer has a porosity of 30% or more, 40% or more, 50% or more, or 65% or more. When the porosity of the porous thermal insulation coating layer is less than 30%, it may be difficult to implement suitable thermal insulation characteristics. The porosity of the porous thermal insulation coating layer means a ratio of all of the pores contained in the porous thermal insulation coating layer. For example, in one cross section of the porous thermal insulation coating layer, the porosity may mean a percent ratio of area occupied by the pores to a total area of the cross section.

For reference, although 20% or less of the polymer compound is included in the granule used for forming the granule coating layer, since the polymer compound has a low density as compared to the ceramic compound, a high porosity may be implemented. However, the porosity is not determined only by an amount of the polymer compound included in the granule, but is affected by coating yield in the GSV process, or the like.

The porous thermal insulation coating layer obtained by the above-mentioned processes may have low thermal conductivity and low volume thermal capacity.

In detail, thermal conductivity of the porous thermal insulation coating layer measured according to ASTM E1461 may be 2.0 W/mK or less, 1.5 W/mK or less, 1.0 W/mK or less, 0.1 to 1.0 W/mK, or 0.3 to 0.7 W/mK.

The thermal conductivity means a degree of capability of a material capable of transferring heat through conduction, and in general, the lower the thermal conductivity, the slower the transfer of thermal kinetic energy, such that a thermal insulation property is excellent. When the thermal conductivity of the porous thermal insulation coating layer is more than 2.0 W/mK, thermal kinetic energy is excessively rapidly transferred, and an amount of thermal energy released to the outside of the porous thermal insulation coating layer is increased, such that the thermal insulation property may be decreased, and thus energy efficiency may be decreased.

In addition, a volume thermal capacity of the porous thermal insulation coating layer measured according to ASTM E1269 may be 3000 kJ/m³K or less, 2500 kJ/m³K or less, 2300 kJ/m³K or less, 1000 to 2300 kJ/m³K, or 1000 to 2050 kJ/m³K. The volume thermal capacity means a quantity of heat required to increase a temperature of a material having a unit volume by 1° C. and may be obtained by the following Equation 1.

Volume Thermal Capacity (kJ/m³K)=Specific Heat (kJ/g*K)×Density (g/m³) [Equation 1]

Therefore, the volume thermal capacity of the porous thermal insulation coating layer is excessively increased to be more than 3000 kJ/m³K, the density of the porous thermal insulation coating layer is increased, and thermal conductivity is also increased, such that it may be difficult to obtain the desired thermal insulation property.

In addition, a density of the porous thermal insulation coating layer measured according to ISO 18754 may be 5.00 g/ml or less, 0.50 to 5.00 g/ml, 1.00 to 4.65 g/ml, or 2.50 to 4.65 g/ml.

When the density of the porous thermal insulation coating layer is more than 5.00 g/ml, it is impossible to decrease thermal conductivity and volume thermal capacity of the porous thermal insulation coating layer to suitable levels, such that a thermal insulation effect may be deteriorated. On the contrary, when the density of the porous thermal insulation coating layer is less than 0.50 g/ml, mechanical properties such as weather resistance, or the like, of the porous thermal insulation coating layer may be deteriorated.

In the manufacturing method of a porous thermal insulation coating layer according to an exemplary embodiment of the present invention, the porous thermal insulation coating layer having excellent close adhesion may be uniformly formed within a shorter time. The porous thermal insulation coating layer formed by the above-mentioned method may secure low thermal conductivity and low volume thermal capacity, and have excellent durability even under harsh conditions of high temperature and high pressure, thereby making it possible to secure improved long-term reliability.

### BRIEF DESCRIPTION OF THE DRAWINGS

FIG. 1 is a process flow chart illustrating a manufacturing method of a porous thermal insulation coating layer according to an exemplary embodiment of the present invention.

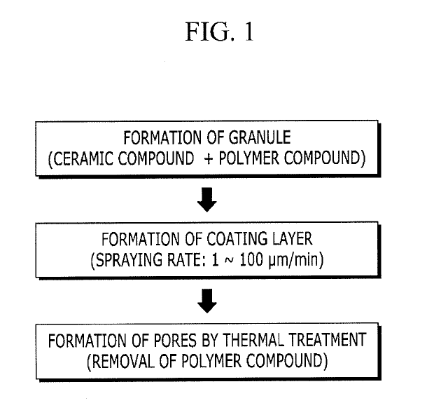

FIG. 2 is a field emission-scanning electron microscope (FE-SEM) image of a surface of a porous thermal insulation coating layer obtained in Example 1.

FIG. 3 is a field emission-scanning electron microscope (FE-SEM) image of a surface of a porous thermal insulation coating layer obtained in Example 2.

FIG. 4 is a field emission-scanning electron microscope (FE-SEM) image of a surface of a porous thermal insulation coating layer obtained in Example 3.

FIG. 5 is a field emission-scanning electron microscope (FE-SEM) image of a surface of a porous thermal insulation coating layer obtained in Comparative Example 1.

FIG. 6 is a field emission-scanning electron microscope (FE-SEM) image of a surface of a porous thermal insulation coating layer obtained in Comparative Example 2.

FIG. 7 is a field emission-scanning electron microscope (FE-SEM) image of a surface of a porous thermal insulation coating layer obtained in Comparative Example 3.

### DETAILED DESCRIPTION

Hereinafter, actions and effects of the present invention will be described in more detail with reference to specific Examples of the present invention. However, the Examples of the present invention have been disclosed for illustrative purposes, but the scopes of the present invention are not limited thereby.

### EXAMPLE 1

(1) Preparation of Granule

: 1000 g of yttria-stabilized zirconia (YSZ, average diameter of about 23 μm) and 10 g of polytetrafluoroethylene (PTFE, weight average molecular weight of about 23,000) were added to and mixed with water. Here, a solid content in the mixture was about 50 vol %.

Then, the mixture was sprayed on a disk at a rotation speed of about 10,000 rpm using a nozzle, thereby forming a spherical droplet. After applying hot wind of 180° C. to dry the spherical droplet, the spherical droplet was thermally treated at a temperature of 900° C. for 4 hours, thereby obtaining a granule having an average diameter of about 56 μm.

(2) Formation of Granule Coating Layer

: A granule coating layer was formed on a substrate specimen for an internal combustion engine by a granule spray in vacuum (GSV) process using the granule. A device including a vacuum chamber provided with a substrate mounting means, a vacuum pump for maintaining a vacuum atmosphere in the vacuum chamber, a spray nozzle spraying the prepared granule in the vacuum chamber together with compressed air, and a granule supplier transferring the prepared granule to the spray nozzle was used in the GSV process.

In the device, the granule provided in the granule supplier was supplied to the spray nozzle by the compressed air, and the supplied granule was sprayed on the substrate specimen provided in the vacuum chamber through the spray nozzle at a rate of 50 μm/min, such that a granule coating layer having a thickness of about 135 μm was formed.

Here, a vacuum atmosphere of 5 torr was maintained in the vacuum chamber. The spraying was performed at a distance at which the spray nozzle was spaced apart from the substrate specimen by 10 mm. The compressed air was sprayed into the vacuum chamber at a flow rate of 30 L/min together with the granule.

(3) Formation of Pores

: The substrate specimen on which the granule coating layer was formed was heated at a temperature of 450° C. for 6 hours to form pores in the granule coating layer, and finally, a substrate specimen on which a porous thermal insulation coating layer having a thickness of about 135 μm was formed was obtained.

### EXAMPLE 2

A substrate specimen on which a porous thermal insulation coating layer having a thickness of about 198 μm was formed was obtained by the same method as in Example 1 except for adjusting a content of polytetrafluoroethylene to 50 g in the preparing of the granule.

### EXAMPLE 3

A substrate specimen on which a porous thermal insulation coating layer having a thickness of about 220 μm was formed was obtained by the same method as in Example 1 except for adjusting a content of polytetrafluoroethylene to 100 g in the preparing of the granule.

### COMPARATIVE EXAMPLE 1

A substrate specimen on which a granule coating layer having a thickness of about 98 μm was formed was obtained by the same method as in Example 1 except that polytetrafluoroethylene was not added in the preparing of the granule (provided that, the forming of the pores was not performed).

### COMPARATIVE EXAMPLE 2

A substrate specimen on which a granule coating layer having a thickness of about 153 μm was formed was obtained by the same method as in Example 1 except that zirconia (average diameter of about 23 μm) was used instead of yttria-stabilized zirconia and polytetrafluoroethylene was not added in the preparing of the granule (provided that, the forming of the pores was not performed).

### COMPARATIVE EXAMPLE 3

(1) Preparation of Granule

: 1000 g of yttria-stabilized zirconia (YSZ, average diameter of about 23 μm) and 10 g of polytetrafluoroethylene (PTFE, weight average molecular weight of about 23,000) were added to and mixed with water. Here, a solid content in the mixture was about 50 vol %.

Then, the mixture was sprayed on a disk at a rotation speed of about 10,000 rpm using a nozzle, thereby forming a spherical droplet. After applying hot wind of 180° C. to dry the spherical droplet, the spherical droplet was thermally treated at a temperature of 900° C. for 4 hours, thereby obtaining a granule having an average diameter of about 56 μm.

In addition, the granule was heated at a temperature of 450° C. for 6 hours, thereby removing PTFE.

(2) Formation of Granule Coating Layer

: A substrate specimen on which a granule coating layer having a thickness of about 103 μm was formed was obtained by the same method as in Example 1 except that the granule from which the PTFE was removed was applied to the GSV process.

### EXAMPLE 4

A substrate specimen on which a porous thermal insulation coating layer having a thickness of about 45 μm was formed was obtained by the same method as in Example 1 except that the granule was sprayed on a substrate specimen at a rate of 10 μm/min at the time of forming the granule coating layer.

### EXAMPLE 5

A substrate specimen on which a porous thermal insulation coating layer having a thickness of about 56 μm was formed was obtained by the same method as in Example 1 except that the granule was sprayed on a substrate specimen at a rate of 100 μm/min at the time of forming the granule coating layer.

### COMPARATIVE EXAMPLE 4

A substrate specimen on which a porous thermal insulation coating layer having a thickness of about 21 μm was formed was obtained by the same method as in Example 1 except that the granule was sprayed on a substrate specimen at a rate of 0.1 μm/min at the time of forming the granule coating layer.

However, in the specimen obtained by the above-mentioned method, the porous thermal insulation coating layer was delaminated, such that it was impossible to measure physical properties according to the following Experimental Example.

### COMPARATIVE EXAMPLE 5

A substrate specimen on which a porous thermal insulation coating layer having a thickness of about 35 μm was formed was obtained by the same method as in Example 1 except that the granule was sprayed on a substrate specimen at a rate of 110 μm/min at the time of forming the granule coating layer.

### EXPERIMENTAL EXAMPLE

FE-SEM

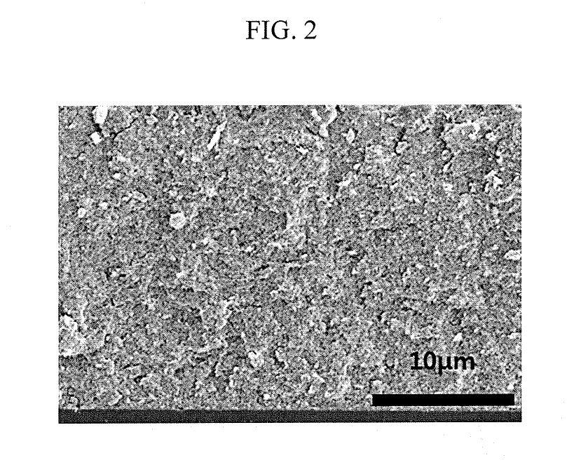

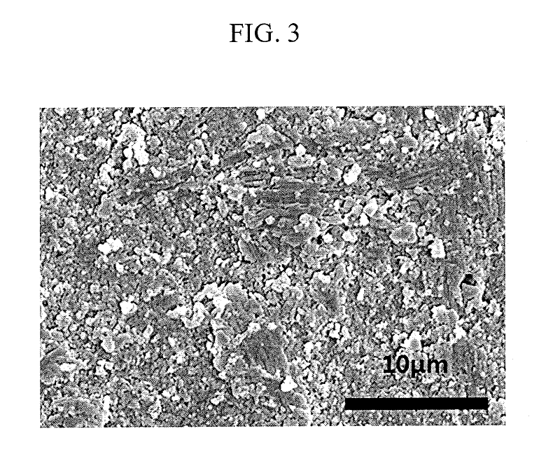

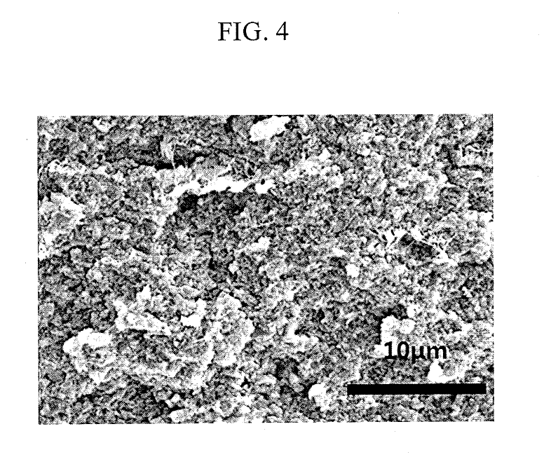

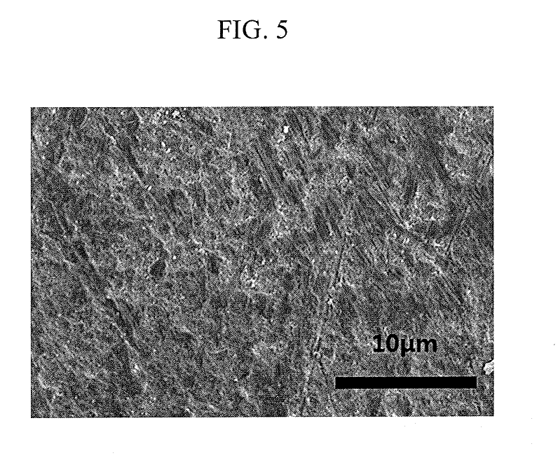

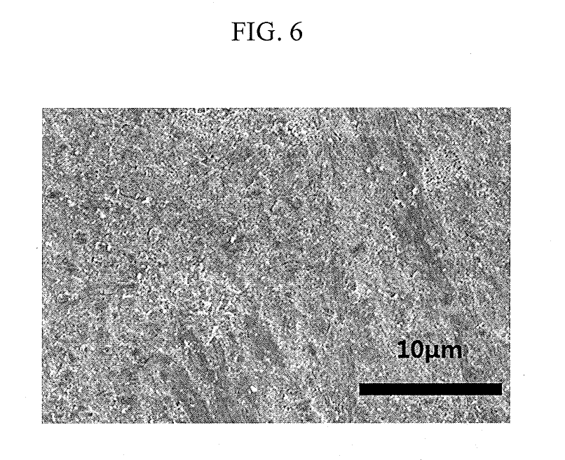

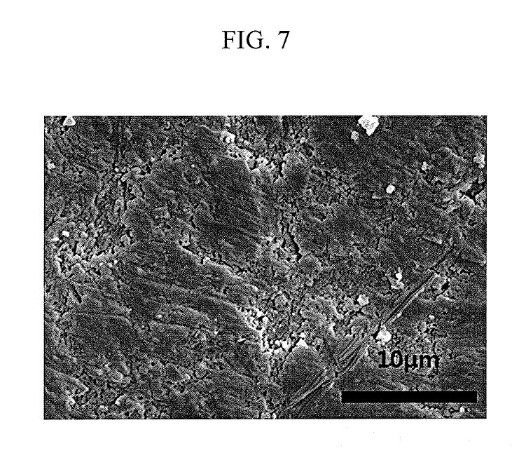

: Surfaces or cross sections of the coating layers of the substrate specimens in Examples 1 to 3 and Comparative Examples 1 to 3 were observed using field emission scanning electron microscope (FE-SEM, HITACHI S-4700, HITACHI, JAPAN), and the results were illustrated in FIGS. 2 to 7.

Thermal Conductivity (W/mK)

: Thermal conductivity of the coating layers obtained in Examples and Comparative Examples was measured by a method of measuring thermal diffusion using a laser flash method according to ASTM E1461 under room temperature and normal pressure conditions, and the results were illustrated in the following Table 1.

Volume Thermal Capacity (kJ/m³K)

: Thermal capacity of the coating layers obtained in Examples and Comparative Examples was measured by measuring specific heat using sapphire as reference and a differential scanning calorimeter (DSC) according to ASTM E1269 under room temperature conditions, and the results were illustrated in the following Table 1.

Density(g/mL)

: Densities of the coating layers obtained in Examples and Comparative Examples were measured according to ISO 18754, and the results were illustrated in the following Table 1.

TABLE 1

| | Thermal | Volume Thermal | |
|---|---|---|---|
| | Conductivity | Capacity | density |
| Classification | (W/mK) | (kJ/m³K) | (g/mL) |
| Example 1 | 0.698 | 2015 | 3.95 |
| Example 2 | 0.533 | 1458 | 3.29 |
| Example 3 | 0.328 | 1128 | 2.84 |
| Example 4 | 0.589 | 1579 | 3.23 |
| Example 5 | 0.920 | 2954 | 4.65 |
| Comparative | 0.930 | 3012 | 5.27 |
| Example 1 | | | |
| Comparative | 1.359 | 3576 | 5.37 |
| Example 2 | | | |
| Comparative | 1.235 | 2371 | 4.98 |
| Example 3 | | | |
| Comparative | Delamination | Delamination | Delamination |
| Example 4 | | | |
| Comparative | 1.321 | 3033 | 4.68 |
| Example 5 | | | |

What is claimed is:

1. A manufacturing method of a porous thermal insulation coating layer, the manufacturing method comprising:
forming a granule including a ceramic compound and a polymer compound;
spraying the granule on a substrate at a rate of 1 μm/min to 100 μm/min to form a granule coating layer; and
forming pores by thermally treating the substrate on which the granule coating layer is formed at a temperature of 300° C. to 500° C. to remove the polymer compound.

2. The manufacturing method of claim 1, wherein: the ceramic compound includes oxides of one or more metals selected from the group consisting of silicon (Si), aluminum (Al), titanium (Ti), zirconium (Zr), calcium (Ca), magnesium(Mg), yttrium (Y), yttria-stabilized zirconia, and cerium (Ce).

3. The manufacturing method of claim 1, wherein: the ceramic compound is a ceramic powder having an average diameter of 1 μm to 50 μm.

4. The manufacturing method of claim 1, wherein: the polymer compound includes one or more compounds selected from the group consisting of polytetrafluoroethylene (PTFE), a tetrafluoroethylene-perfluoroalkylvinylether copolymer (PFA), a tetrafluoroethylene-hexafluoropropylene copolymer (FEP), an ethylene-tetrafluoroethylene copolymer (ETFE), a tetrafluoroethylene-chlorotrifluoroethylene copolymer (TFE/CTFE), ethylene-chlorotrifluoroethylene (ECTFE), polyethylene, polystyrene, poly(methyl methacrylate), poly(ethylene oxide), poly(vinyl alcohol), and polyamide.

5. The manufacturing method of claim 1, wherein: the granule is composed of 80 to 99.9 wt % of the ceramic compound and 0.1 to 20 wt % of the polymer compound.

6. The manufacturing method of claim 1, wherein: the granule has an average diameter of 50 μm to 500 μm.

7. The manufacturing method of claim 1, wherein: the forming of the granule coating layer is performed under vacuum.

8. The manufacturing method of claim 1, wherein: the forming of the granule coating layer includes,
supplying the granule to a spray nozzle using compressed air; and
spraying the supplied granule to the substrate provided in a vacuum chamber through the spray nozzle.

9. The manufacturing method of claim 8, wherein: the spraying is performed at a distance at which the spray nozzle is spaced apart from the substrate by 5 mm to 200 mm.

10. The manufacturing method of claim 8, wherein: the compressed air is supplied at a flow rate of 20 to 50 L/min, and a vacuum atmosphere of 1 to 50 torr is maintained in the vacuum chamber.

11. The manufacturing method of claim 1, wherein: the granule coating layer has a thickness of 10 μm to 2000 μm.

12. The manufacturing method of claim 1, wherein: the substrate is an inner surface or a component of an internal combustion engine.
